(19) United States
(12) Patent Application Publication
(10) Pub. No.: US 2025/0149820 A1
(43) Pub. Date: May 8, 2025

(54) CONNECTOR DEVICE

(71) Applicant: SUMITOMO WIRING SYSTEMS, LTD., Mie (JP)

(72) Inventors: Hiroki OKANO, Mie (JP); Kengo TAKAGI, Mie (JP)

(21) Appl. No.: 18/935,269

(22) Filed: Nov. 1, 2024

(30) Foreign Application Priority Data
Nov. 6, 2023 (JP) 2023-189433

(51) Int. Cl. H01R 13/516; H01R 13/506

(52) U.S. Cl. CPC H01R 13/516; H01R 13/506

(57) ABSTRACT

A connector device includes a connector, and a holder configured to accommodate the connector thereinside. The connector includes a housing provided with a plurality of cavities, and a busbar held in the housing. The plurality of cavities are aligned in a left-right direction. The busbar includes a plurality of tabs located at the front end portions of the cavities. The housing has a flat shape with the length in the left-right direction being longer than the length in a vertical direction. The holder includes left and right side wall surfaces configured to face left and right side surfaces of the connector when the connector is accommodated inside the holder. Left and right side surfaces of the housing include connector-side locking portions. The left and right side wall surfaces of the holder include holder-side locking portions configured to be locked to the connector-side locking portions.

### CROSS-REFERENCE TO RELATED APPLICATIONS

This application is based on and claims priority from Japanese Patent Application No. 2023-189433, filed on Nov. 6, 2023, with the Japan Patent Office, the disclosure of which is incorporated herein in its entirety by reference.

### TECHNICAL FIELD

The present disclosure relates to a connector device.

### BACKGROUND

Conventionally, a connector is known that includes a plate-shaped conductive member having a plurality of tabs and a housing that holds the conductive member, for example, as described in JP 2013-073925A. The housing is provided with terminal accommodation portions. The tabs protrude inside the terminal accommodation portions. Female terminals connected to the terminal portions of electric wires are inserted into the terminal accommodation portions. The female terminals inserted into the terminal accommodation portions are electrically connected to the tabs. The housing of this type of connector often has a flat shape extending along the plate surface of the conductive member. Note that JP 2007-184188A and JP 2008-098021A disclose a connector that includes a retainer.

### SUMMARY

There has been a demand to use a connector that includes a plate-shaped conductive member as described above in a state of being accommodated in a holder fixed to a vehicle body or the like. In this case, it is necessary to provide a locking structure for enabling the holder to hold the connector. However, for example, when the connector is disposed in the holder in the vertical direction, it is desired to avoid an increase in the height of the flat housing as much as possible.

Therefore, it is an object of the present disclosure to provide a connector device capable of accommodating and holding the connector in the holder without an increase in the height of the flat housing.

A connector device of the present disclosure is a connector device including: a connector; and a holder configured to accommodate the connector thereinside, wherein the connector includes a housing provided with a plurality of cavities, and a busbar held in the housing, female terminal fittings are capable of being inserted into the cavities from a rear side, the plurality of cavities are aligned in a left-right direction, the busbar includes a plurality of tabs located at a front end portions of the cavities, the housing has a flat shape with a length in the left-right direction being longer than a length in a vertical direction, the holder includes left and right side wall surfaces configured to face left and right side surfaces of the connector when the connector is accommodated inside the holder, left and right side surfaces of the housing are provided with connector-side locking portions, and the left and right side wall surfaces of the holder are provided with holder-side locking portions configured to be locked to the connector-side locking portions.

With the present disclosure, it is possible to provide a connector device capable of accommodating and holding the connector in the holder without an increase in the height of the flat housing.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a connector device according to Embodiment 1, illustrating a state in which a connector is accommodated in a holder.

FIG. 2 is a perspective view of the connector device in a state in which the connector is not accommodated in the holder yet.

FIG. 3 is an exploded perspective view of the connector.

FIG. 4 is a side view of the connector.

FIG. 5 is a bottom view of the connector.

FIG. 6 is a cross-sectional view of the connector device in a state in which the connector is accommodated in the holder.

FIG. 7 is an enlarged cross-sectional view of a portion of the connector device in a state in which the connector is accommodated in the holder, illustrating an enlarged view of a locking structure for locking the holder and the connector.

FIG. 8 is an enlarged cross-sectional view of a portion of the connector device, illustrating a state in which the connector is being accommodated in the holder.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of the Present Disclosure

First, aspects of the present disclosure will be listed and described.
[1] A connector device of the present disclosure is a connector device including: a connector; and a holder configured to accommodate the connector thereinside, wherein the connector includes a housing provided with a plurality of cavities, and a busbar held in the housing, female terminal fittings are capable of being inserted into the cavities from a rear side, the plurality of cavities are aligned in a left-right direction, the busbar includes a plurality of tabs located at a front end portions of the cavities, the housing has a flat shape with a length in the left-right direction being longer than a length in a vertical direction, the holder includes left and right side wall surfaces configured to face left and right side surfaces of the connector when the connector is accommodated inside the holder, left and right side surfaces of the housing are provided with connector-side locking portions, and the left and right side wall surfaces of the holder are provided with holder-side locking portions configured to be locked to the connector-side locking portions. With this configuration, the connector-side locking portions need not be provided on the upper surface or the lower surface of the housing, thus making it possible to accommodate and hold the connector in the holder without an increase in the height of the flat housing.
[2] The connector device according to [1] above may have a configuration in which the left and right side wall surfaces of the holder each include a locking arm extending in the form of a cantilever from a back side of the holder toward an opening, the holder-side locking portions are provided on locking arms, and leading end portions of the locking arms are located on a front side with respect to an open end of the holder. With this configuration, the locking arms can be easily deformed in an unlocking direction compared with a case where the holder-side locking portions are disposed on the back side of the holder. Accordingly, when it is desired to remove the connector from the holder, the holder-side locking portions can be easily unlocked from the connector-side locking portion.
[3] The connector device according to [2] above may have a configuration in which the holder-side locking portions protrude inward in a left-right direction from the locking arms, and include holder-side contact surfaces configured to come into contact with the connector-side locking portions when the connector is inserted into the holder, and the holder-side contact surfaces are each inclined to gradually increase a protrusion dimension toward the back side from a leading end side of the locking arm. With this configuration, the connector-side locking portions smoothly get on tops of the holder-side locking portions due to the inclinations of the holder-side contact surfaces provided on the holder-side locking portions, thus making it possible to smoothly insert the connector into the holder.
[4] The connector device according to any one of [1] to [3] above may have a configuration in which the connector includes a retainer for preventing dislodgement of the female terminal fittings inserted into the cavities, the retainer includes a main body extending in the left-right direction, and latching portions provided at two end portions in the left-right direction of the main body, latching groove portions to which the latching portions are fitted are recessed in the left and right side surfaces of the housing, the latching groove portions are each provided with displacement preventing surfaces inclined to prevent the latching portion from being displaced outward in the left-right direction. With this configuration, it is possible to prevent the latching portions of the retainer from being displaced outward in the left-right direction to form steps on the side surfaces of the connector, thus making it possible to smoothly insert the connector into the holder.
[5] The connector device according to [4] above may have a configuration in which the connector-side locking portions protrude outward in the left-right direction from the left and right side surfaces of the housing, and each include a connector-side contact surface configured to come into contact with the holder-side locking portion when the connector is inserted into the holder, and the connector-side contact surfaces are each continuous with the displacement preventing surfaces and are inclined to gradually increase a protrusion dimension rearward from a front side. With this configuration, the connector-side locking portions smoothly get on tops of the holder-side locking portions due to the inclinations of the holder-side contact surfaces and the connector-side contact surfaces, thus making it possible to smoothly insert the connector into the holder.

### Details of Embodiments of the Present Disclosure

The following describes specific examples of a connector device of the present disclosure with reference to the drawings. Note that the present invention is not limited to these examples and is defined by the scope of the appended claims, and all changes that fall within the same essential spirit as the scope of the claims are intended to be included therein.

### Embodiment 1

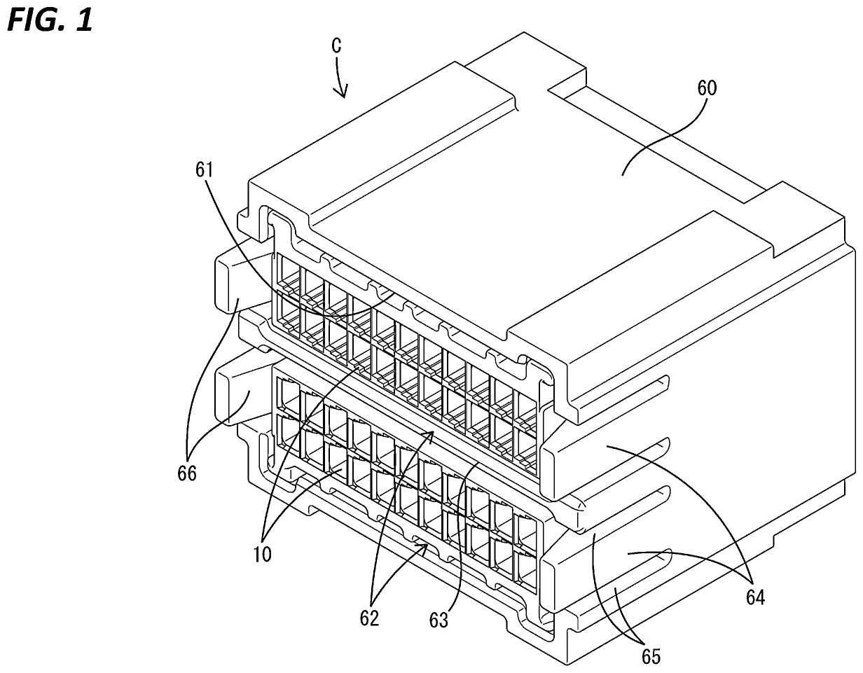

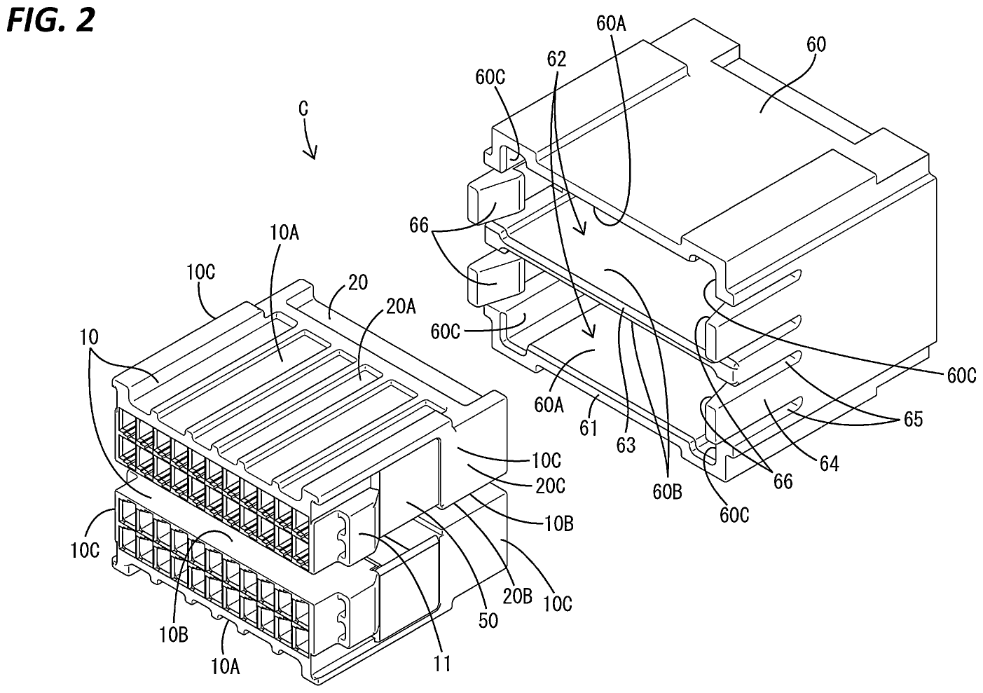

As shown in FIGS. 1 and 2, a connector device C includes two connectors 10 and a holder 60. The two connectors 10 are inserted into the holder 60 through an open end 61. The holder 60 is provided with two accommodation portions 62 in each of which the connector 10 is accommodated.

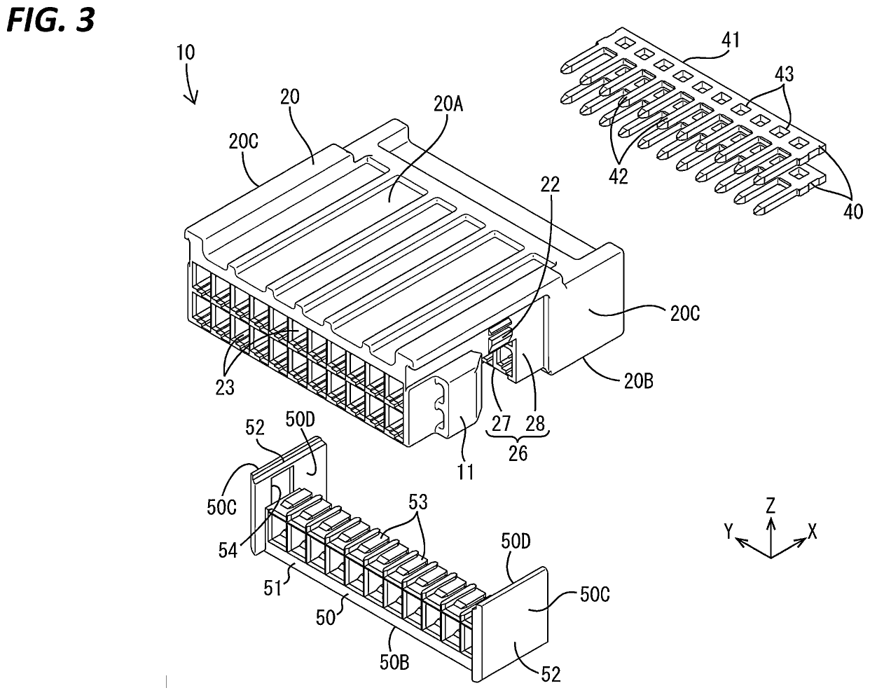

In the description of the holder 60, a side on which the open end 61 is provided is taken as the front side, and a side located on the back side of the accommodation portions 62 is taken as the rear side. In the description of the connectors 10, a front side in a direction in which the connectors 10 are inserted into the holder 60 is taken as the front side. In both of the description of the holder 60 and the description of the connectors 10, the vertical direction is based on the vertical direction in FIG. 1, and the left-right direction is a direction orthogonal to the vertical direction and the front-rear direction. These definitions of the directions are for the purpose of describing the connector device C, and the directions do not necessarily coincide with the corresponding directions when the connector device C is being used. In FIGS. 3 to 5 showing only the connector 10, “the front side”, “the left side”, and “the upper side” are represented by symbols X, Y, and Z, respectively.

As shown in FIG. 2, the holder 60 includes a partition wall 63 that separates the two accommodation portions 62. The two accommodation portions 62 are aligned in the vertical direction. Each of the accommodation portions 62 is elongated in the left-right direction. The dimension in the vertical direction of the accommodation portion 62 is smaller than the dimension in the left-right direction.

As shown in FIG. 2, when accommodated in the accommodation portions 62, the two connectors 10 face opposite sides in the vertical direction. The two connectors 10 have the same structure. In the description of the connectors 10, a side on which a retainer 50 is attached is taken as the lower side.

As shown in FIG. 2, each of the accommodation portions 62 is surrounded by an upper wall surface 60A, a lower wall surface 60B, and left and right side wall surfaces 60C. When the connector 10 is accommodated in the holder 60, the upper wall surface 60A faces an upper surface 10A of the connector 10, the lower wall surface 60B faces a lower surface 10B of the connector 10, and the left and right side wall surfaces 60C respectively face left and right side surfaces 10C of the connector 10. Both of the upper and lower surfaces of the partition wall 63 are the lower wall surfaces 60B that face the lower surfaces 10B of the connectors 10.

In each of the accommodation portions 62, the upper wall surface 60A and the lower wall surface 60B are parallel with each other. In each of the accommodation portions 62, the left and right side wall surfaces 60C are parallel with each other. Holder-side locking portions 66 are provided on the left and right side wall surfaces 60C. The holder-side locking portions 66 are provided so as to form two rows in the vertical direction, and a pair is made in the left-right direction in each row. Four holder-side locking portions 66 are provided in total.

As shown in FIG. 2, the holder-side locking portions 66 are provided on locking arms 64. Each of the locking arms 64 is formed between upper and lower slits 65. The slits 65 linearly extend rearward from the open end 61 of the holder 60. The locking arms 64 extend forward from the rear side in the form of a cantilever. The locking arms 64 are elastically displaceable in the left-right direction with the displacement starting at the rear end. The leading end portions of the locking arms 64 protrude forward with respect to the open end 61 of the holder 60. The holder-side locking portions 66 will be described in detail later.

As shown in FIG. 3, each of the connectors 10 includes a housing 20, two busbars 40, and a retainer 50. The two busbars 40 are arranged so as to form two rows in the vertical direction with respect to the housing 20. Each of the busbars 40 is formed by punching a conductive metal plate. The busbar 40 includes a coupling portion 41 and a plurality of tabs 42. The coupling portion 41 extends in the left-right direction. The coupling portion 41 is provided with a plurality of coupling holes 43. The plurality of tabs 42 are aligned in the left-right direction and protrude rearward from the rear edge of the coupling portion 41. The two busbars 40 are inserted into the housing 20 from the front side and are attached thereto.

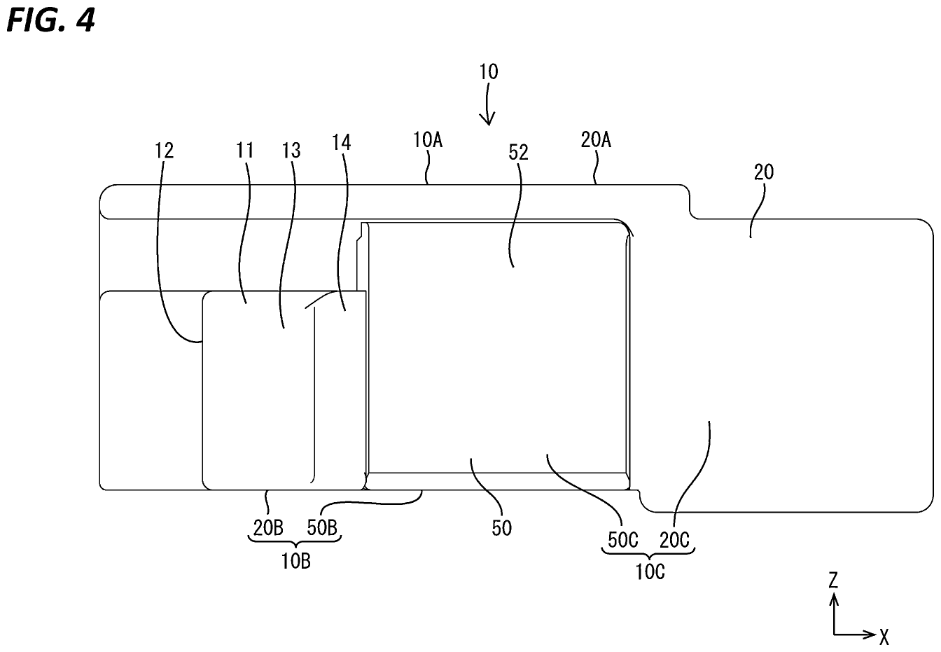

The retainer 50 is pressed into the housing 20 from the lower side to the upper side and is attached thereto. The retainer 50 is made of a synthetic resin and includes a main body 51 and latching portions 52. The main body 51 extends in the left-right direction. The main body 51 is provided with a plurality of terminal latching portions 53 to be locked to female terminal fittings (not illustrated). When being attached to the housing 20, the retainer 50 is locked to the female terminal fittings inserted into cavities 23 to prevent dislodgement of the female terminal fittings. The female terminal fittings are made of a conductive metal and are connected to terminal portions of electric wires (not illustrated). When the retainer 50 is attached to the housing 20, a lower surface 50B of the main body 51 is flush with a lower surface 20B of the housing 20 (see FIG. 4). The lower surface 50B of the main body 51 and the lower surface 20B of the housing 20 constitute the lower surface 10B of the connector 10.

As shown in FIG. 3, the left and right latching portions 52 are provided at two end portions in the left-right direction of the main body 51. Each of the latching portions 52 has a wall shape and protrudes upward from the main body 51. The latching portion 52 is provided with a latching recessed portion 54. The latching recessed portion 54 is locked to a latching protruding portion 22 provided on the housing 20. The latching recessed portion 54 is provided on an interior surface 50D located on the interior side in the left-right direction of the latching portion 52. Due to the latching recessed portions 54 being locked to the latching protruding portions 22, the retainer 50 is held in a state of being attached to the housing 20.

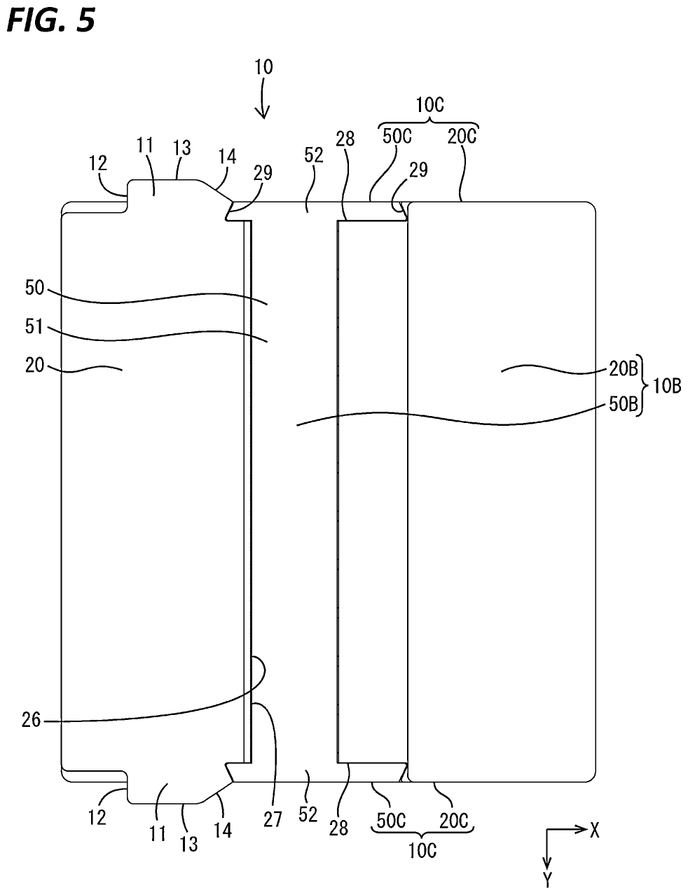

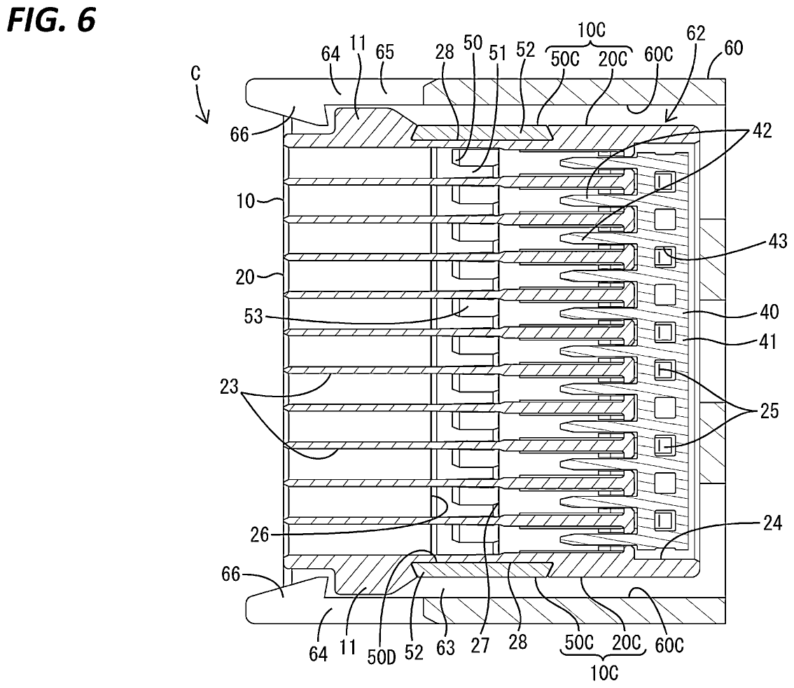

As shown in FIG. 5, each of the latching portions 52 has a shape fitted to a latching groove portion 28, which will be described later. Specifically, as shown in FIG. 6, a cross-section of the latching portion 52 in a direction orthogonal to the vertical direction has a trapezoidal shape, which corresponds to the shape of the latching groove portion 28. When the retainer 50 is attached to the housing 20, exterior surfaces 50C of the latching portions 52 on the exterior side in the left-right direction are flush with left and right side surfaces 20C of the housing 20 (see FIG. 5). The exterior surfaces 50C of the latching portions 52 and the left and right side surfaces 20C of the housing 20 constitute the left and right side surfaces 10C of the connector 10.

The housing 20 is made of a synthetic resin and has a flat shape extending along the plate surfaces of the busbars 40 as shown in FIG. 3. The dimension in the vertical direction of the housing 20 is smaller than the dimension in the left-right direction. The dimension in the left-right direction of the housing 20 is larger than the dimension in the front-rear direction.

The housing 20 is provided with a plurality of cavities 23. The plurality of cavities 23 are arranged so as to form two rows in the vertical direction. In each row, the cavities 23 are aligned in the left-right direction. The female terminal fittings are inserted into the cavities 23 from the rear side.

As shown in FIG. 6, the front end portion of the housing 20 is provided with a busbar attachment portion 24. The busbar attachment portion 24 is provided on the front side with respect to the cavities 23. Two busbar attachment portions 24 are provided so as to correspond to the cavities 23 arranged in two rows. The busbar attachment portions 24 are open forward. The busbars 40 are inserted into the busbar attachment portions 24 from the front side. Each of the busbar attachment portions 24 is provided with a plurality of latching protrusions 25. The latching protrusions 25 are fitted to the coupling holes 43 of the busbar 40 and thus prevent dislodgement of the busbar 40. The tabs 42 are disposed at the front end portions of the cavities 23 and individually protrude.

As shown in FIG. 3, the housing 20 is provided with a retainer attachment portion 26. The retainer attachment portion 26 includes a main body fitting groove portion 27 and latching groove portions 28. The main body 51 of the retainer 50 is fitted to the main body fitting groove portion 27. The latching portions 52 of the retainer 50 are fitted to the latching groove portions 28.

As shown in FIG. 6, the main body fitting groove portion 27 is formed at an intermediate position in the front-rear direction of the cavities 23 and extends in the left-right direction. The main body fitting groove portion 27 is open in the lower surface 20B of the housing 20 (see FIGS. 3 and 5). The latching groove portions 28 are recessed in the left and right side surfaces 20C of the housing 20. The latching protruding portions 22 protrude from the latching groove portions 28 (see FIG. 3).

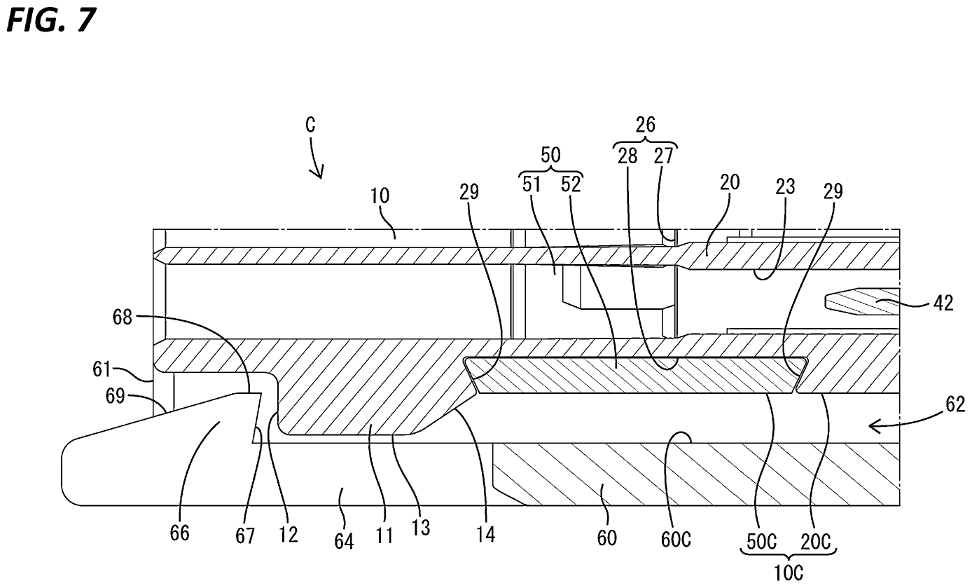

As shown in FIG. 7, each of the latching groove portions 28 includes displacement preventing surfaces 29. The displacement preventing surfaces 29 prevent the latching portion 52 from being displaced outward in the left-right direction. The displacement preventing surfaces 29 constitute the front and rear surfaces of the latching groove portion 28. The front displacement preventing surface 29 is inclined outward from the interior side in the left-right direction, and rearward. The rear displacement preventing surface 29 is inclined outward from the interior side in the left-right direction, and forward. The dimension in the front-rear direction of each of the latching groove portions 28 gradually decreases outward from the interior side in the left-right direction.

As shown in FIG. 5, each of the left and right side surfaces 20C of the housing 20 is provided with a connector-side locking portion 11. The connector-side locking portions 11 protrude outward in the left-right direction from the left and right side surfaces 20C of the housing 20.

As shown in FIG. 4, each of the connector-side locking portions 11 extends from a position slightly above the center in the vertical direction of the housing 20 to the lower end of the housing 20. The left and right connector-side locking portions 11 have the same structure, and therefore, only one of them will be described.

As shown in FIG. 7, the connector-side locking portion 11 includes a connector-side latching surface 12, a connector-side guide surface 13, and a connector-side contact surface 14. The connector-side latching surface 12 is provided at the rear end of the connector-side locking portion 11. The connector-side latching surface 12 is nearly orthogonal to the left and right side surfaces 20C of the housing 20. The connector-side latching surface 12 is located on the front side with respect to the rear end of the housing 20.

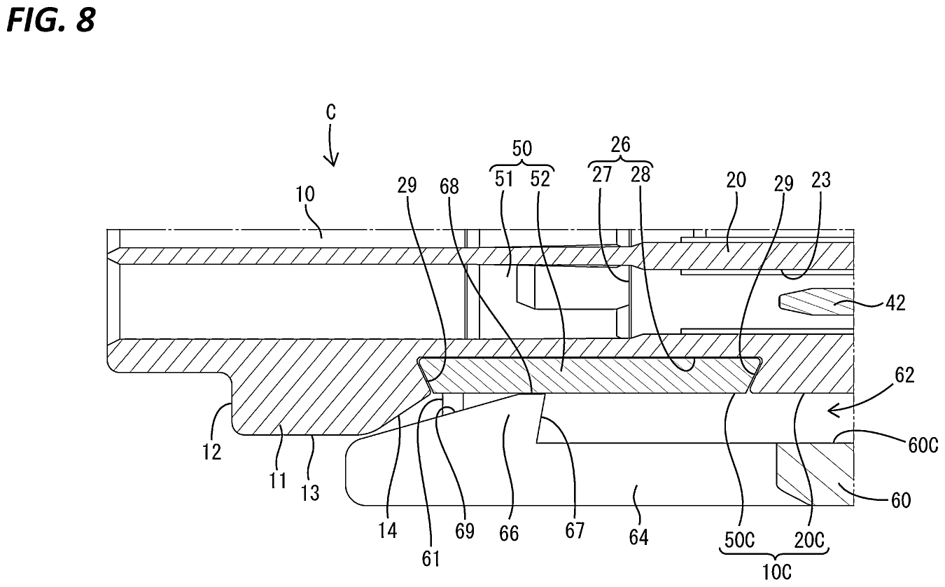

The connector-side contact surface 14 is provided on the front side of the connector-side locking portion 11. The connector-side contact surface 14 comes into contact with the holder-side locking portion 66 when the connector 10 is inserted into the holder 60 (see FIG. 8). The connector-side contact surface 14 is inclined such that the protrusion dimension gradually increases rearward from the front side. The connector-side contact surface 14 is continuous with the displacement preventing surface 29. In other words, the front end of the connector-side contact surface 14 and the exterior end in the left-right direction of the displacement preventing surface 29 are located at the same position. Thus, the exterior surface 50C of the latching portion 52 and the connector-side contact surface 14 are continuous with each other in the front-rear direction with no space therebetween.

The connector-side guide surface 13 is provided between the connector-side latching surface 12 and the connector-side contact surface 14. The connector-side guide surface 13 is parallel with the left and right side surfaces 20C of the housing 20.

As shown in FIG. 7, the holder-side locking portion 66 is provided at the free end portion of the locking arm 64. The holder-side locking portion 66 protrudes inward in the left-right direction from the locking arm 64. About a half portion in the front-rear direction of the holder-side locking portion 66 is located on the front side with respect to the open end 61 of the holder 60.

The holder-side locking portion 66 includes a holder-side latching surface 67, a holder-side guide surface 68, and a holder-side contact surface 69. The holder-side latching surface 67 is provided at the rear end of the holder-side locking portion 66. The holder-side latching surface 67 is nearly orthogonal to the interior surface of the locking arm 64. The holder-side latching surface 67 is located on the rear side with respect to the open end 61 of the holder 60. The holder-side locking portion 66 and the connector-side locking portion 11 are locked to each other inside the accommodation portion 62.

The holder-side contact surface 69 is provided on the front side of the holder-side locking portion 66. The holder-side contact surface 69 comes into contact with the connector-side locking portion 11 when the connector 10 is inserted into the holder 60 (see FIG. 8). The holder-side contact surface 69 is inclined such that the protrusion dimension gradually increases rearward from the front side.

The holder-side guide surface 68 is provided between the holder-side latching surface 67 and the holder-side contact surface 69. The holder-side guide surface 68 is parallel with the interior surface of the locking arm 64. The dimension in the front-rear direction of the holder-side guide surface 68 is smaller than the dimension in the front-rear direction of the connector-side guide surface 13.

Next, an example of the operation to insert the connector 10 into the accommodation portion 62 through the open end 61 of the holder 60. As shown in FIG. 8, the latching portions 52 of the retainer 50 are disposed while being prevented by the displacement preventing surfaces 29 of the latching groove portions 28 from being separated outward in the left-right direction. This prevents formation of steps on the left and right side surfaces 10C of the connector 10. The left and right side surfaces 10C of the connector 10 are smoothly inserted toward the back side of the holder 60 without being caught by the holder-side locking portions 66. The connector-side contact surfaces 14 come into contact with the holder-side contact surfaces 69, and when the connector 10 is further pressed into the accommodation portion 62, the locking arms 64 are elastically displaced outward in the left-right direction, and the connector-side locking portions 11 pass on the interior side with respect to the holder-side locking portions 66. As shown in FIG. 7, the connector-side locking portions 11 are moved to the back side with respect to the holder-side locking portions 66, and the locking arms 64 are elastically restored. Thus, the connector-side latching surfaces 12 are locked to the holder-side latching surfaces 67. In this manner, the operation to insert the connector 10 into the holder 60 is completed. The operation to insert the connector 10 into the holder 60 is conducted without need for that great force because the connector-side contact surfaces 14 and the holder-side contact surfaces 69 are inclined.

When the connector 10 is removed from the holder 60, the locking arms 64 are elastically displaced outward in the left-right direction by applying force outward in the left-right direction on the leading end portions of the locking arms 64 using fingers, a jig, or the like. Thus, the holder-side locking portions 66 are unlocked from the connector-side locking portions 11, and the connector 10 can be removed from the holder 60. Here, if the locking arms are provided on the back side of the holder, it is necessary to insert a jig to the back side of the holder and press the locking arms in an unlocking direction in order to remove the connector from the holder. In contrast, with the connector device C, the leading end portions of the locking arms 64 protrude outward from the open end 61 of the holder 60, thus making it easy to press the locking arms 64 in the unlocking direction. Accordingly, the connector 10 can be easily removed from the holder 60.

The following describes the functions and effects of the embodiment configured as described above. The connector device C includes the connectors 10, and the holder 60 configured to accommodate the connectors 10 thereinside. The connectors 10 each include the housing 20 and the busbars 40. The housing 20 is provided with a plurality of cavities 23. The busbars 40 are held in the housing 20. Female terminal fittings are capable of being inserted into the cavities 23 from the rear side. The plurality of cavities 23 are aligned in the left-right direction. The busbars 40 each include a plurality of tabs 42 located at the front end portions of the cavities 23. The housing 20 has a flat shape with the length in the left-right direction being longer than the length in the vertical direction. The holder 60 includes the left and right side wall surfaces 60C configured to face the left and right side surfaces 10C of the connectors 10 when the connectors 10 are accommodated inside the holder 60. The left and right side surfaces 20C of the housing 20 are provided with the connector-side locking portions 11, and the left and right side wall surfaces 60C of the holder 60 are provided with the holder-side locking portions 66 configured to be locked to the connector-side locking portions 11. With this configuration, the connector-side locking portions 11 need not be provided on the upper surface 20A or the lower surface 20B of the housing 20, thus making it possible to accommodate and hold the connector 10 in the holder 60 without an increase in the height of the flat housing 20.

The left and right side wall surfaces 60C of the holder 60 each include the locking arm 64 extending in the form of a cantilever from the back side of the holder 60 toward the open end 61. The holder-side locking portions 66 are provided on locking arms 64. The leading end portions of the locking arms 64 are located on the front side with respect to the open end 61 of the holder 60. With this configuration, the locking arms 64 can be easily deformed in an unlocking direction compared with a case where the holder-side locking portions are disposed on the back side of the holder. Accordingly, when it is desired to remove the connector 10 from the holder 60, the holder-side locking portions 66 can be easily unlocked from the connector-side locking portions 11.

The holder-side locking portions 66 protrude inward in the left-right direction from the locking arms 64. The holder-side locking portions 66 each include the holder-side contact surface 69. The holder-side contact surfaces 69 come into contact with the connector-side locking portions 11 when the connector 10 is inserted into the holder 60. The holder-side contact surfaces 69 are each inclined such that the protrusion dimension gradually increases toward the back side of the holder 60 from the leading end side of the locking arm 64. With this configuration, the connector-side locking portions 11 smoothly get on top of the holder-side locking portions 66 due to an inclination of the holder-side contact surfaces 69 provided on the holder-side locking portions 66, thus making it possible to smoothly insert the connector 10 into the holder 60.

The connectors 10 each include the retainer 50 for preventing dislodgement of the female terminal fittings inserted into the cavities 23. The retainer 50 includes the main body 51 and latching portions 52. The main body 51 extends in the left-right direction. The latching portions 52 are provided at two end portions in the left-right direction of the main body 51. The latching groove portion 28 to which the latching portions 52 are fitted are recessed in the left and right side surfaces 20C of the housing 20. The latching groove portions 28 are each provided with the displacement preventing surfaces 29. The displacement preventing surfaces 29 are inclined to prevent the latching portion 52 from being displaced outward in the left-right direction. With this configuration, it is possible to prevent the latching portions 52 of the retainer 50 from being displaced outward in the left-right direction to form steps on the side surfaces 10C of the connector 10, thus making it possible to smoothly insert the connector 10 into the holder 60.

The connector-side locking portions 11 protrude outward in the left-right direction from the left and right side surfaces 20C of the housing 20. The connector-side locking portions 11 each include the connector-side contact surface 14. The connector-side contact surfaces 14 come into contact with the holder-side locking portions 66 when the connector 10 is inserted into the holder 60. The connector-side contact surfaces 14 are continuous with the displacement preventing surfaces 29. The connector-side contact surfaces 14 are each inclined such that the protrusion dimension gradually increases rearward from the front side. With this configuration, the connector-side locking portions 11 smoothly get on top of the holder-side locking portions 66 due to inclinations of the holder-side contact surfaces 69 and the connector-side contact surfaces 14, thus making it possible to smoothly insert the connector 10 into the holder 60.

### Other Embodiments of the Present Disclosure

The embodiments disclosed herein are exemplary in all respects, and should be construed as being not limitative.

In the embodiment above, the holder 60 is provided with two accommodation portions 62 in each of which the connector 10 is accommodated, but in another embodiment, the holder may be provided with only one accommodation portion for accommodating the connector, or three or more accommodation portions.

In the embodiment above, the busbars 40 are arranged so as to form two rows in the vertical direction with respect to the housing 20, but in another embodiment, only one row of the busbar may be disposed, or three or more rows of the busbar may be disposed.

In the embodiment above, the holder-side locking portions 66 are provided on the locking arms 64, but in another embodiment, a configuration may be employed in which the holder is provided with no locking arms and the holder-side locking portions are directly provided on the left and right side wall surfaces of the holder.

In the embodiment above, the dimension in the left-right direction of the housing 20 is larger than the dimension in the front-rear direction, but in another embodiment, the dimension in the left-right direction of the housing may be smaller than the dimension in the front-rear direction.

In the embodiment above, the leading end portions of the locking arms 64 protrude forward with respect to the open end 61 of the holder 60, but in another embodiment, the leading end portions of the locking arms may be located on the rear side with respect to the open end of the holder.

In the embodiment above, not only the holder-side contact surfaces 69 but also the connector-side contact surfaces 14 are inclined, but in another embodiment, either the holder-side contact surfaces 69 or the connector-side contact surfaces 14 may be inclined.

In the embodiment above, the latching groove portions 28 each include the displacement preventing surfaces 29, but in another embodiment, the latching groove portions need not be provided with the displacement preventing surfaces.

In the embodiment above, the connector-side contact surfaces 14 are continuous with the displacement preventing surfaces 29, but in another embodiment, the connector-side contact surfaces may be provided at positions away from the displacement preventing surfaces.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector device comprising:
a connector; and
a holder configured to accommodate the connector thereinside,
wherein the connector includes a housing provided with a plurality of cavities, and a busbar held in the housing,
female terminal fittings are capable of being inserted into the cavities from a rear side,
the plurality of cavities are aligned in a left-right direction,
the busbar includes a plurality of tabs located at a front end portions of the cavities,
the housing has a flat shape with a length in the left-right direction being longer than a length in a vertical direction,
the holder includes left and right side wall surfaces configured to face left and right side surfaces of the connector when the connector is accommodated inside the holder,
left and right side surfaces of the housing are provided with connector-side locking portions, and
the left and right side wall surfaces of the holder are provided with holder-side locking portions configured to be locked to the connector-side locking portions.

2. The connector device according to claim 1,
wherein the left and right side wall surfaces of the holder each include a locking arm extending in the form of a cantilever from a back side of the holder toward an opening,
the holder-side locking portions are provided on locking arms, and
leading end portions of the locking arms are located on a front side with respect to an open end of the holder.

3. The connector device according to claim 2,
wherein the holder-side locking portions protrude inward in a left-right direction from the locking arms, and include holder-side contact surfaces configured to come into contact with the connector-side locking portions when the connector is inserted into the holder, and
the holder-side contact surfaces are each inclined to gradually increase a protrusion dimension toward the back side from a leading end side of the locking arm.

4. The connector device according to claim 1,
wherein the connector includes a retainer for preventing dislodgement of the female terminal fittings inserted into the cavities,
the retainer includes a main body extending in the left-right direction, and latching portions provided at two end portions in the left-right direction of the main body,
latching groove portions to which the latching portions are fitted are recessed in the left and right side surfaces of the housing,
the latching groove portions are each provided with displacement preventing surfaces inclined to prevent the latching portion from being displaced outward in the left-right direction.

5. The connector device according to claim 4,
wherein the connector-side locking portions protrude outward in the left-right direction from the left and right side surfaces of the housing, and each include a connector-side contact surface configured to come into contact with the holder-side locking portion when the connector is inserted into the holder, and
the connector-side contact surfaces are each continuous with the displacement preventing surfaces and are inclined to gradually increase a protrusion dimension rearward from a front side.
